(19) United States
(12) Patent Application Publication
(10) Pub. No.: US 2016/0129816 A1
(43) Pub. Date: May 12, 2016

(54) HEADREST DEVICE

(71) Applicants: HYUNDAI MOTOR COMPANY, Seoul (KR); HYUNDAI DYMOS INCORPORATED, Seosan-si (KR)

(72) Inventors: Tae Hoon LEE, Seoul (KR); Dong Woo JEONG, Seongnam-si (KR); Hyun Kyu PARK, Suwon-si (KR); Mi Sun KWON, Seoul (KR); Sang Hark LEE, Incheon (KR); Sang Do PARK, Suwon-si (KR); Hoon Bok LEE, Seoul (KR); Jin Ho SEO, Yongin-si (KR); Sung Chol AN, Hwaseong-si (KR); Myeong Seop KIM, Seongnam-si (KR); Yun Ho KIM, Osan-si (KR); Dong Hwan KIM, Hwaseong-si (KR); Jun Kyu KIM, Hwaseong-si (KR); Gi Tae JO, Hwaseong-si (KR)

(21) Appl. No.: 14/639,103

(22) Filed: Mar. 4, 2015

(30) Foreign Application Priority Data
Nov. 12, 2014 (KR) 10-2014-0156818

(51) Int. Cl. B60N 2/48

(52) U.S. Cl. CPC B60N 2/4864; B60N 2/4852

(57) ABSTRACT

A headrest device comprises a fixed bracket fixed at a headrest stay and having a driving portion. A first link bracket is connected to the driving portion and a headrest panel which is connected to a headrest cushion, thus the first link bracket moving forward upon actuation of the driving portion. A second link bracket is rotatably connected to the headrest panel and the fixed bracket, respectively, and the first link bracket is connected to the second link bracket. When the first link bracket moves forward, the second link bracket rotatably moves forward together with the first link bracket, thereby tilting the headrest cushion and at the same time moving forward.

### CROSS REFERENCE TO RELATED APPLICATION

The present application claims the benefit of priority to Korean Patent Application No. 10-2014-0156818, filed in the Korean Intellectual Property Office on Nov. 12, 2014, the entire contents of which is incorporated herein for all purposes by this reference.

### TECHNICAL BACKGROUND

The present disclosure relates to a headrest device, and in particular, to a headrest device which improves user convenience by adjusting a position of a headrest forward and backward.

### BACKGROUND

A headrest of a vehicle is provided at an upper side of a seat to stably support a head of a user such as a driver and passenger, thereby providing comfort to the user, eliminating tiredness, protecting the head from any impact, and reducing an injury by stably supporting a user's neck.

In general, a pair of headrest stays are inserted into the upper side of the seat, and a headrest locking means for fixing a position of the headrest stay or adjusting a vertical height upon adjusting the position is provided at the upper side of the seat.

In recent days, the headrest does not only support the head of the rider, but also improve user convenience by adjusting the height of the headrest and a forward and backward position.

For instance, an annular rod having a circle shape in the related art is provided at an upper side of a headrest stay. The support plate covers the annular rod and is slidingly provided along an exterior circumferential surface of the annular rod.

However, in the conventional technology, a forward and backward movement range of the headrest is limited, and since a structure itself is not rigid, a failure easily occurs at the time of occurrence of impact.

The description provided above as a related art of the present disclosure is just for helping in understanding the background of the present disclosure and should not be construed as being included in the related art known by those skilled in the art.

### SUMMARY

The present disclosure is suggested to solve the problems described above and has an object of providing a headrest device which supports comfortably a head of a rider by constructing the headrest device such that a position of the headrest can be adjusted forward and backward and an actuation range of the headrest is secured.

According to an exemplary embodiment of the present inventive concept, a headrest device includes a fixed bracket fixed at a headrest stay and having a driving portion. A first link bracket is connected to the driving portion and a headrest panel which is connected to a headrest cushion, thus moving forward upon actuation of the driving portion. A second link bracket is rotatably connected to the headrest panel and the fixed bracket, respectively, and the first link bracket is connected to the second link bracket. When the first link bracket moves forward the second link bracket rotatably moves forward together with the first link bracket, thereby making the headrest cushion to be tilted and at the same time move forward.

The fixed bracket may be fixed between rods on both sides of the headrest stay, and the driving portion is fixed between the both rods.

The driving portion may comprise a drive motor fixed to the fixed bracket to provide an actuating force and a lead screw extending forward from the drive motor and screwed to the first link bracket.

A stopper bracket may be provided at one end of the lead screw to prevent an excessive forward movement of the first link bracket.

A guide rod may extend parallel to the lead screw and is connected to the stopper bracket at the fixed bracket, and the first link bracket penetrates and is connected to the guide rod.

The first link bracket may comprise a movement member moving along the lead screw upon actuation of the driving portion by being screwed to the lead screw of the driving portion. A link member has one end rotatably connected to a lower side of the headrest panel and another end attached to the movement member.

The link members may be provided in a plural number to be symmetrical to both ends of the movement member.

The second link bracket may have one end rotatably connected to the fixed bracket and another end is rotatably connected to an upper side of the headrest panel. The link member of the first link bracket is connected to a middle portion of the second link bracket.

The second link bracket may have a backward bent shape, so that the one end and the other end thereof are extend further forward than the middle portion.

A guide recess may extend vertically at the one end of the link member, and a hinge pin may be inserted into the guide recess at the middle portion of the second link bracket.

A guide recess may extend vertically at the upper side of the headrest panel, and the other end of the second link bracket is inserted into and connected to the guide recess.

### BRIEF DESCRIPTION OF THE DRAWINGS

The above and other features of the present disclosure will now be described in detail with reference to exemplary embodiments thereof illustrating the accompanying drawings which are given herein below by way of illustration only, and thus are not limitative of the present invention.

FIG. 1 is a perspective view of a headrest device according to an embodiment of the present inventive concept.

FIG. 2 is a perspective view showing an operation of the headrest device shown in FIG. 1.

FIG. 3 is an exploded view of the headrest device according to an embodiment of the present inventive concept.

FIG. 4 is a side view of the headrest device shown in FIG. 1.

FIG. 5 is a side view showing an operation of the headrest device shown in FIG. 1.

It should be understood that the appended drawings are not necessarily to scale, presenting a somewhat simplified representation of various features of the present inventive concept as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that the present description is not intended to limit the inventive concept to those exemplary embodiments. On the contrary, the inventive concept is intended to cover the exemplary embodiments as well as various alternatives, modifications, equivalents and other embodiments, which may be included within the spirit and scope of the disclosure as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a headrest device according to an embodiment of the present inventive concept will be described with reference to the accompanying drawings.

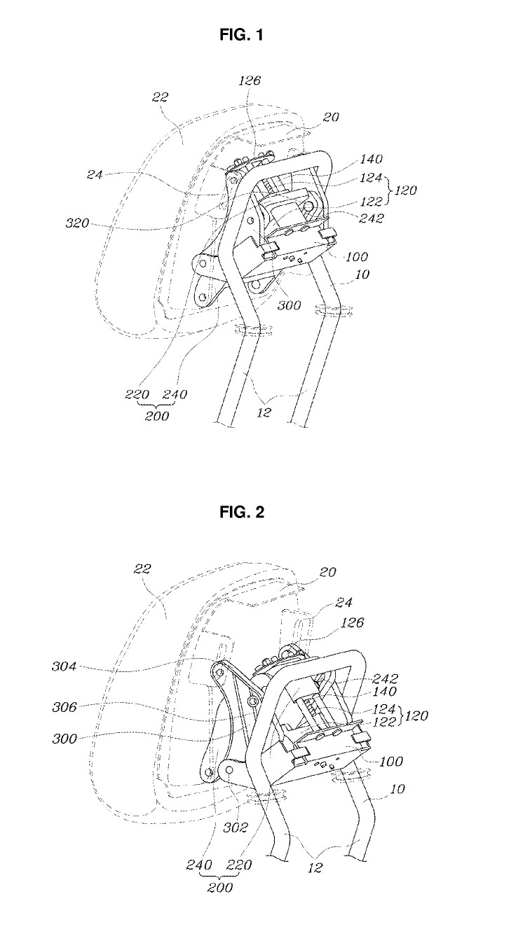

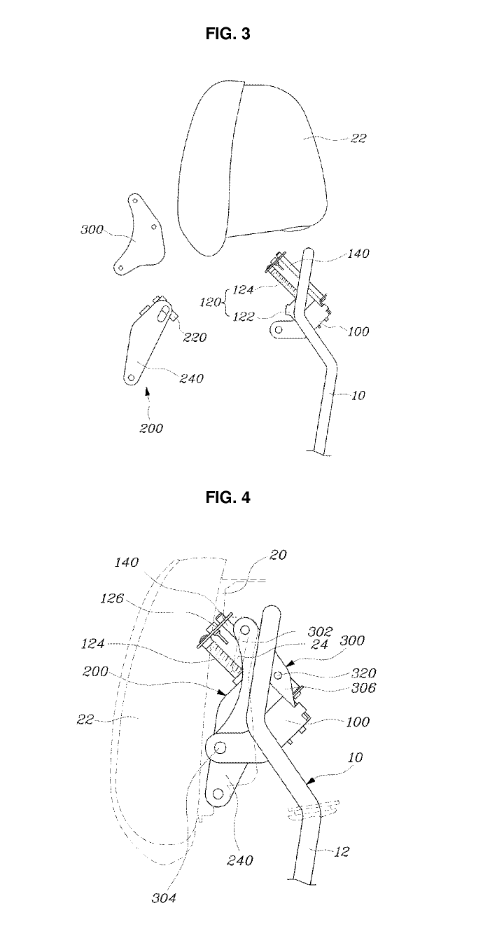

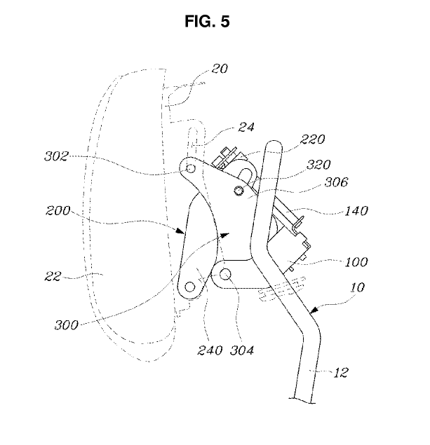

FIG. 1 is a perspective view of a headrest device according to an embodiment of the present inventive concept, FIG. 2 is a perspective view illustrating an operation of the headrest device shown in FIG. 1, and FIG. 3 is an exploded view of the headrest device according to an embodiment of the present inventive concept. In addition, FIG. 4 is a side view of the headrest device shown in FIG. 1, and FIG. 5 is a side view illustrating an operation of the headrest device shown in FIG. 1.

The headrest device of the present disclosure comprises a fixed bracket 100 which is installed to be fixed at a headrest stay 10 and is provided with a driving portion 120. A first link bracket 200 is connected to each of the driving portion 120 and a headrest panel 20 connected to a headrest cushion 22 to be moved forward upon actuation of the driving portion 120. A second link bracket 300 is rotatably connected to the headrest panel 20, the fixed bracket 100 respectively, the first link bracket 200, so that when the first link bracket 200 moves forward the second link bracket 300 moves forward together with the first link bracket 200, thereby moving the headrest cushion 22 forward and to be tilted.

According to the headrest of the present disclosure, a position of the headrest can be adjusted forward and backward, in which a module for adjusting the position forward and backward is installed in the headrest. That is, the driving portion 120 is provided at the fixed bracket 100 which is fixed at an upper end of the headrest stay 10. When the first link bracket 200 which is connected to the driving portion 120 moves forward upon actuation of the driving portion 120, the second link bracket 300 rotatably moves together with the first link bracket 200, whereby the headrest panel 20 which is connected to the first link bracket 200 and the second link bracket 300 moves forward. Accordingly, a position of the headrest cushion 22 installed at the headrest panel 20 moves to adjust the position of the headrest to a position which the rider wants.

More specifically, the fixed bracket 100 is fixed between rods 12 on both sides of the headrest stay 10, and the driving portion 120 is fixed between the rods 12. In this way, the fixed bracket 100 is firmly fixed by connecting both rods 12 of the headrest stay 10. This fixed bracket 100 has a panel shape disposed between both rods 12 of the headrest stay 10 so that the driving portion 120 can be mounted on the fixed bracket 100.

The driving portion 120 comprises a drive motor 122 fixed to the fixed bracket 100 to provide an actuating force and a lead screw 124 extending forward from the drive motor 122 and screwed to the first link bracket 200.

As described above, the driving portion 120 comprises the drive motor 122 and a lead screw 124 connected to the drive motor 122, and the drive motor 122 receives a signal through a separate actuation switch or control portion, and the lead screw 124 rotates upon actuation of the drive motor 122, whereby the first link bracket 200 moves forward. Here, a penetration hole (not shown) to which the lead screw 124 is connected by penetrating can be formed in the middle of the first link bracket 200, and a thread for screwing the lead screw 124 can be formed in the inner circumference of the penetration hole (not shown).

In particular, the lead screw 124 of the driving portion 120 extends to be inclined forward and upward, whereby the first link bracket 200 moves diagonally upon actuation of the driving portion 120 to secure actuation when the second link bracket 300 rotatably moves.

On the one hand, a stopper bracket 126 is provided at one end of the lead screw 124 to limit an excessive forward movement of the first link bracket 200. That is, the stopper bracket 126 provided at the end of the lead screw 124 defines a position the headrest cushion 22 can be moved forward to the maximum to limit the maximum actuation radius of the headrest cushion 22. In addition, if the drive motor 122 is excessively actuated according to an actuation error, whereby the first link bracket 200 is excessively actuated along the lead screw 124, then the first link bracket 200 is caught by the stopper bracket 126, thereby preventing the first link bracket 200 from escaping from the lead screw 124.

On the one hand, a guide rod 140, which extends parallel to the lead screw 124 and is connected to the stopper bracket 126, is provided at the fixed bracket 100, and the first link bracket 200 penetrates and is connected to the guide rod 140. This guide rod 140 guides the first link bracket 200 to move along the lead screw 124, and at the same time supports a load of the headrest together with the lead screw 124.

The lead screw 124 of the driving portion 120 is screwed to the first link bracket 200 to provide a passage for the movement of the first link bracket 200, and if the lead screw 124 is bent by an external element, the first link bracket 200 cannot satisfactorily move. Therefore, by further providing the guide rod 140 to the fixed bracket 100, the guide rod 140 together with the lead screw 124 can support the load of the headrest.

On the one hand, as can be seen in FIG. 1, the first link bracket 200 comprises a movement member 220 moving along the lead screw 124 upon actuation of the driving portion 120 by being screwed to the lead screw 124 of the driving portion 120, and a link member 240 one end of which is rotatably installed to a lower side of the headrest panel 20 and another end of which is mounted to the movement member 220.

Here, the lead screw 124 can penetrate a center of the movement member 220, and a thread can be formed at an inner circumference surface of the penetrated hole. The movement member 220 can be connected to the lead screw 124 of the driving portion 120 to move along a direction of extension of the lead screw 124, and the link member 240 is connected to both ends of the movement member 220. One end of the link member 240 is installed at the lower side of the headrest panel 20 together with the second link bracket 300 to support the headrest panel 20.

The link members 240 can be provided in a plural number and symmetrically combined to both ends of the movement member 220, whereby the headrest panel 20 is firmly supported with balance.

One end 302 of the second link bracket 320 is rotatably connected to the fixed bracket 100, another end 304 of the second link bracket 320 is rotatably connected to the upper side of the headrest panel 20, and thus, the link member 240 of the first link bracket 200 can be connected to a middle portion 306.

This second link bracket 300 is interlocked with the first link bracket 200 which moves forward upon the actuation of the driving portion 120. However, the second link bracket 300 rotatably moves forward with the one end 302 as a center of rotation since the one end 302 is connected to the fixed bracket 100. Here, the other end 304 of the second link bracket 300 is connected to the upper side of the headrest panel 20, thereby together with the link member 240 of the first link bracket 200 described above supporting the headrest panel 20. That is, the other end 304 of the second link bracket 300 is connected to the upper side of the headrest panel 20, and the link member 240 of the first link bracket 200 is connected to the lower side of the headrest panel 20, thereby stably supporting the headrest panel 20.

The second link bracket 300 has a backward bent shape, so that the one end 302 and the other end 304 extends further forward than the middle portion 306. Therefore, upon the movement of the first link bracket 200 according to the actuation of the driving portion 120, the middle portion 306 of the second link bracket 300 moves diagonally forward, whereby the other end 304 rotatably moves forward with the one end 302 as the center of rotation. In particular, the second link bracket 300 is bent so that the other end 304 extends further forward than the middle portion 306, a radius of rotation is large enough to sufficiently secure the amount of forward movement of the headrest panel 20.

A first guide recess 242 which extends vertically can be formed at one end of the link member 240, and a hinge pin 320 which is inserted into the first guide recess 242 can be provided at the middle portion 306 of the second link bracket 300. In the present disclosure, the movement member 220 of the first link bracket 200 moves upon the actuation of the driving portion 120, whereby the link member 240 linearly moves. At this time, the second link bracket 300 connected to one end of the link member 240 rotates, so that there is a vertical height deviation in terms of a radius of actuation of the link member 240 and the second link bracket 300.

Therefore, by the first guide recess 242 formed vertically at one end of the link member 240 and a hinge pin 320 formed at the middle portion 306 of the second link bracket 300, the link member 240 moves linearly along the lead screw 124 when the drive motor 122 is actuated. The second link bracket 300 rotatably moves, and the hinge pin 320 moves along the first guide recess 242, whereby the second link bracket 300 rotates as desired.

A second guide recess 24 which extends vertically can be provided at an upper side of the headrest panel 20, and the other end 304 of the second link bracket 300 can be inserted into and connected to the second guide recess 24. The second guide recess 24 is provided at the headrest panel 20 and the other end 304 of the second link bracket 300 is inserted into the second guide recess 24, thus when the second link bracket rotates, the second link bracket does not continuously push the headrest panel 20 but moves along the second guide recess 24.

The link member 240 of the first link bracket 200 which is connected to the lower side of the headrest panel 20 moves forward as much as the extended length of the lead screw 124 of the driving portion 120. In this case, if the headrest panel 20 moves as much as the rotation of the second link bracket 300, the upper side of the headrest panel 20 can excessively move forward.

Therefore, due to the second guide recess 24 provided at the headrest panel 20 and other end of the second link bracket 300 inserted into the second guide recess 24, when the second link bracket 300 rotates a certain amount, the other end of the second link bracket 300 moves downward along the second guide recess 24, thereby making the upper side and the lower side of the headrest panel 20 to stably move forward.

Hereinafter, the actuation condition of the present disclosure described above will be described.

As shown in FIGS. 1 and 4, initially the driving portion 120 is not actuated, and accordingly, the movement member 220 of the first link bracket 200 is provided at a rear end of the lead screw 124, and accordingly the second link bracket 300 is fixed in a rotated state. Thereby, the headrest panel 20 maintains to be fixed toward a rear side.

Here, the driving portion 120 is driven by actuating an operation switch to adjust a length of the headrest in a forward and backward direction. Therefore, as shown in FIGS. 2 and 5, the lead screw 124 rotates in accordance with the actuation of the drive motor 122 of the driving portion 120, the movement member 220 of the first link bracket 200 screwed to the lead screw 124 moves along an extension direction of the lead screw 124. In this way, when the movement member 220 moves forward, the link member 240 connected to the movement member 220 moves along the extension direction of the lead screw 124, the lower side of the headrest panel 20 moves forward.

At the same time, the second link bracket 300 connected to the link member 240 rotates with the one end 302 rotatably connected to the fixed bracket 100, and the other end 304 rotates forward so that the upper side of the headrest panel 20 moves forward.

Here, when the second link bracket 300 rotates, the other end 304 of the second link bracket 300 moves downward along the second guide recess 24 of the headrest panel 20 so that the upper side and the lower side of the headrest panel 20 move forward with a balance. Therefore, the headrest cushion 22 connected to the headrest panel 20 moves forward to comfortably support the head of the rider.

The headrest device can support the head of the rider comfortably by constructing the headrest device in such a way that the position of the headrest can be adjusted forward and backward and at the same time the actuation range of the headrest is secured. Therefore, the convenience of the rider using the headrest is improved.

According to the present disclosure, the headrest device described above supports the head of the rider comfortably in such a way that the position of the headrest can be adjusted forward and backward, and at the same time the actuation range of the headrest is secured. Therefore, the convenience of the rider using the headrest is improved.

The inventive concept has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A headrest device comprising:
a fixed bracket fixed at a headrest stay and having a driving portion;
a first link bracket connected to the driving portion and a headrest panel which is connected to a headrest cushion, thus the first link bracket moving forward upon actuation of the driving portion; and
a second link bracket rotatably connected to the headrest panel, the fixed bracket, and the first link bracket, respectively such that when the first link bracket moves forward, the second link bracket rotatably moves forward together with the first link bracket, thereby tilting and at the same time moving the headrest cushion forward.

2. The headrest device of claim 1, wherein the fixed bracket is fixed between rods on both sides of the headrest stay, and the driving portion is fixed between the rods.

3. The headrest device of claim 1, wherein the driving portion comprises a drive motor fixed to the fixed bracket to provide an actuating force and a lead screw extending forward from the drive motor and screwed to the first link bracket.

4. The headrest device of claim 3, wherein a stopper bracket is mounted at one end of the lead screw to prevent an excessive forward movement of the first link bracket.

5. The headrest device of claim 4, wherein a guide rod, which extends parallel to the lead screw and is connected to the stopper bracket, is mounted at the fixed bracket, and to which the first link bracket penetrates and is connected.

6. The headrest device of claim 3, wherein the first link bracket comprises:
a movement member moving along the lead screw upon the actuation of the driving portion by being screwed to the lead screw of the driving portion; and
a link member having one end rotatably connected to a lower side of the headrest panel and another end connected to the movement member.

7. The headrest device of claim 6, wherein the link members are provided in a plural number to be symmetrically connected to both ends of the movement member.

8. The headrest device of claim 6, wherein the second link bracket has one end rotatably mounted at the fixed bracket and another end rotatably mounted at an upper side of the headrest panel, and the link member of the first link bracket is connected to a middle portion of the second link bracket.

9. The headrest device of claim 8, wherein the second link bracket has a backward bent shape, such that the one end and the other end thereof further extend forward than the middle portion.

10. The headrest device of claim 8, wherein a first guide recess extending vertically is formed at the one end of the link member, and a hinge pin inserted into the first guide recess is provided at the middle portion of the second link bracket.

11. The headrest device of claim 8, wherein a second guide recess extends vertically at the upper side of the headrest panel, and the other end of the second link bracket is inserted into and connected to the second guide recess.

12. The headrest device of claim 2, wherein the fixed bracket has a panel shape.

13. The headrest device of claim 3, wherein the lead screw extends to be inclined forward and upward, and the first link bracket moves diagonally upon the actuation of the driving portion.
